(19) United States
(12) Patent Application Publication
(10) Pub. No.: US 2010/0053794 A1
(43) Pub. Date: Mar. 4, 2010

(54) THERMALLY ASSISTED MAGNETIC RECORDING METHOD, MAGNETIC RECORDING HEAD, MAGNETIC RECORDING MEDIUM, AND MAGNETIC RECORDING APPARATUS

(75) Inventors: Hideki Mashima, Odawara (JP); Keiichi Nagasaka, Isehara (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/498,636

(22) Filed: Jul. 7, 2009

(30) Foreign Application Priority Data
Aug. 29, 2008 (JP) 2008-222186

(51) Int. Cl. G11B 5/02

(52) U.S. Cl. 360/59; G9B/5.026

(57) ABSTRACT

In a thermally assisted magnetic recording method, tunneling current is applied from a tunneling current wiring arranged on a magnetic recording head configured to fly above a magnetic recording medium having a bit pattern formed of recording bits separated from one another by an insulator to a desired recording bit of the magnetic recording medium, so that the recording bit is heated and thus coercivity of the recording bit is reduced. Then, an alternating magnetic field corresponding to information to be recorded is applied from the magnetic recording head to the heated recording bit, so that the information can be recorded in the magnetic recording medium.

### CROSS-REFERENCE TO RELATED APPLICATION(S)

This application is based upon and claims the benefit of priority of the prior Japanese Patent Application No. 2008-222186, filed on Aug. 29, 2008, the entire contents of which are incorporated herein by reference.

### FIELD

The embodiments discussed herein are directed to a thermally assisted magnetic recording method, a magnetic recording head and a magnetic recording medium for the thermally assisted magnetic recording method, and a magnetic recording apparatus including the magnetic recording head and the magnetic recording medium.

### BACKGROUND

In recent years, a recording density of a magnetic memory such as a hard disk drive (HDD) is becoming increasingly higher to satisfy a demand for a smaller and lighter apparatus.

With increase in the recording density, magnetic recording bits (hereinafter, “recording bits”) of an HDD is becoming smaller, leading to problems concerning “thermal fluctuation” of recorded information (magnetization). To prevent the thermal fluctuation and achieve the high recording density at the same time, a thermally assisted magnetic recording technology has been proposed. In this technology, information is recorded by heating highly heat-resistant magnetic material of a magnetic recording medium so that coercivity of the magnetic material is reduced to a level at which the information can be recorded.

For example, Japanese Laid-open Patent Publication No. 04-176034 discloses a conventional thermally assisted magnetic recording method. In this method, a light is applied from an optical head having a light source and a light waveguide to a magnetic recording medium, so that a magnetic layer of the magnetic recording medium for magnetic recording (hereinafter, “recording magnetic layer”) is heated and thus coercivity of the recording magnetic layer is reduced. Then, a recording magnetic field is applied from a magnetic pole of a magnetic recording head to the recording magnetic layer, so that information is magnetically recorded in the recording magnetic layer. The recording magnetic layer is then cooled to room temperature and thus the coercivity increases, so that the magnetically-recorded information can be assured.

Furthermore, Japanese Laid-open Patent Publication No. 2005-327467 discloses a thermally assisted magnetic recording method using an electron emission source and a magnetic recording head. More particularly, the electron emission source emits electron towards a magnetic recording medium to heat a recording magnetic layer of the magnetic recording medium, so that information can be magnetically recorded with a recording magnetic field applied from a magnetic recording head.

However, in the conventional thermally assisted recording method using a light, magnetization reversal of a recording bit in which information is not to be recorded may occur because of fundamental limitation of a beam spot size. Therefore, it is difficult to increase recording resolution. Besides, a light source is arranged outside of a flying slider, so that a configuration of the magnetic recording head becomes complicated.

Furthermore, in the thermally assisted recording method using emission of electron, mounting of the electron emission source on the magnetic recording head is not sufficient to effectively apply electric current only to a specific area of a recording magnetic layer when the electric current is applied to a magnetic recording medium. Therefore, similar to the thermally assisted recording method mentioned earlier, it is difficult to increase the recording resolution.

### SUMMARY

According to an aspect of the present invention, a thermally assisted magnetic recording method includes applying tunneling current from a tunneling current wiring arranged on a magnetic recording head configured to fly above a magnetic recording medium having a bit pattern formed of recording bits separated from one another by an insulator to a desired recording bit of the magnetic recording medium, thereby heating the recording bit and reducing coercivity of the recording bit; and applying an alternating magnetic field corresponding to information to be recorded from the magnetic recording head to the recording bit heated at the heating to record the information in the magnetic recording medium.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 is a schematic diagram of an example of a magnetic recording head according to an embodiment of the present invention;

FIG. 2 is a schematic diagram of the example of the magnetic recording head according to the embodiment;

FIG. 3 is a schematic diagram of another example of the magnetic recording head according to the embodiment;

FIGS. 4A to 4C are schematic diagrams of an example of a magnetic recording medium according to the embodiment;

FIG. 5 is a schematic diagram of an example of a magnetic recording apparatus according to the embodiment; and

FIG. 6 is a schematic diagram for explaining a thermally assisted magnetic recording method according to the embodiment.

### DESCRIPTION OF EMBODIMENT(S)

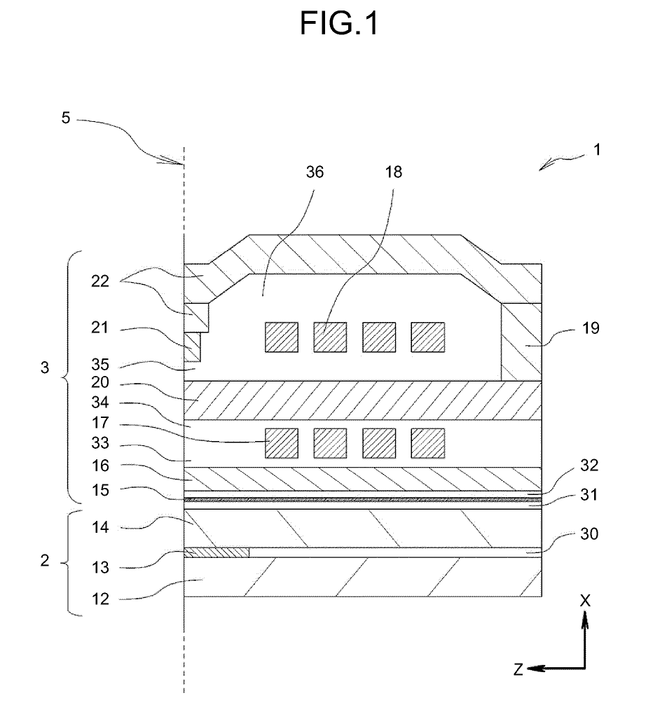

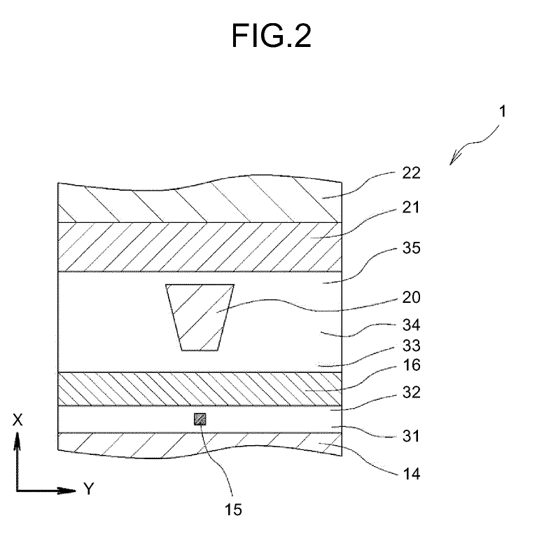

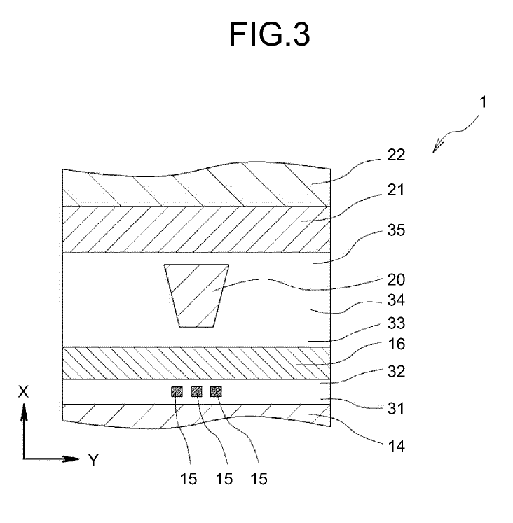

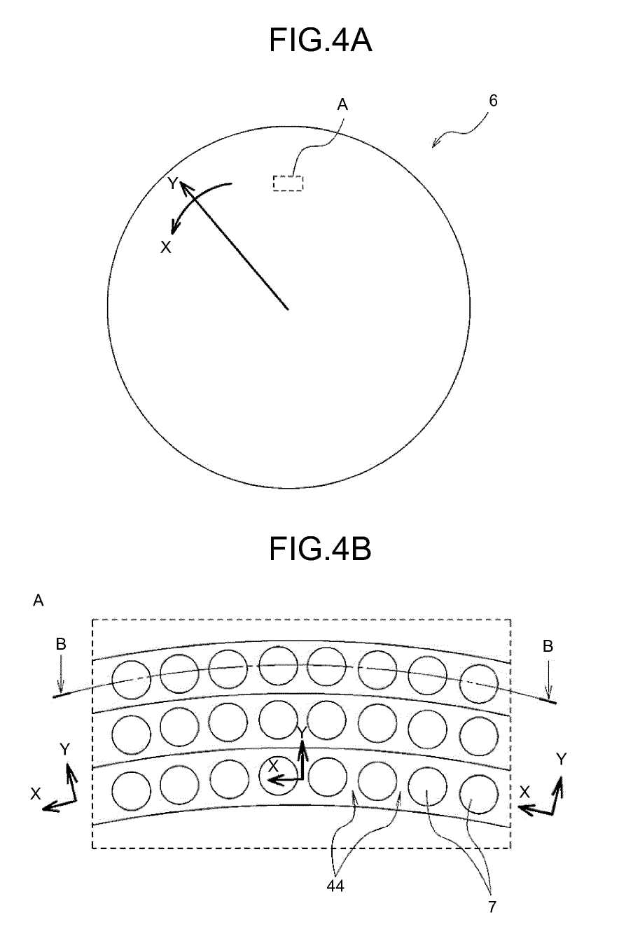

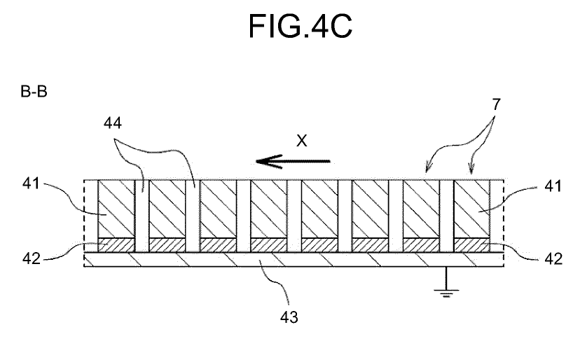

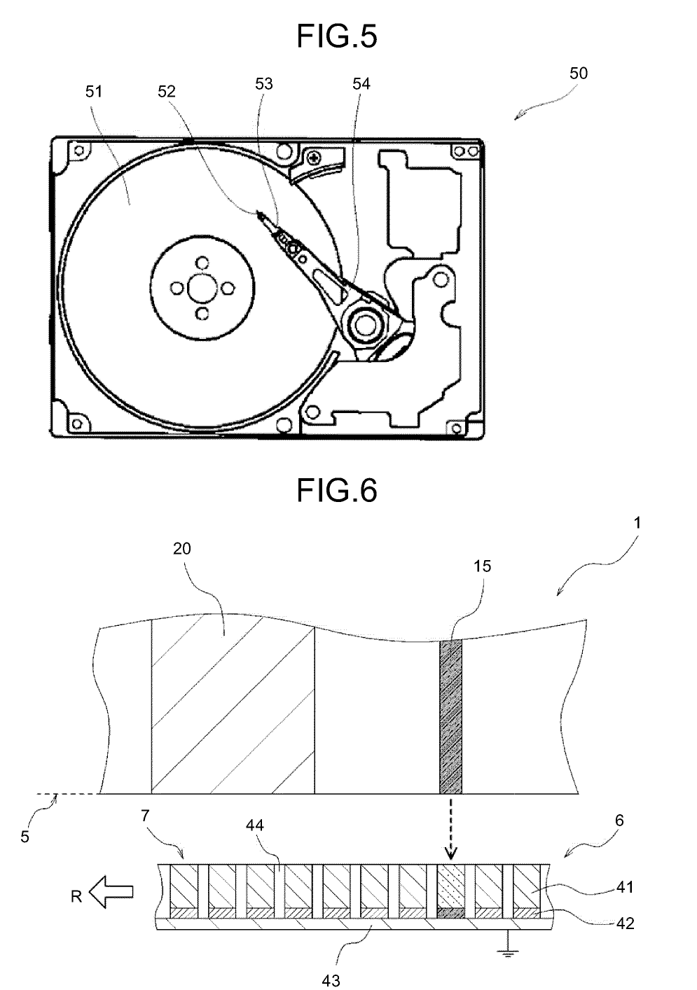

Preferred embodiments of the present invention will be explained in detail below with reference to the accompanying drawings. FIG. 1 is a schematic diagram of an example of a magnetic recording head 1 according to an embodiment of the present invention (a sectional view, viewed from a direction perpendicular to a core-width direction). FIG. 2 is an end view of the magnetic recording head 1 illustrated in FIG. 1, viewed from a medium facing surface 5 side. FIG. 3 is a schematic diagram of another example of the magnetic recording head 1 according to the embodiment (an end view, viewed from the medium facing surface 5 side). FIGS. 4A to 4C are schematic diagrams of an example of a magnetic recording medium 6 according to the embodiment. More particularly, FIG. 4 is an overall view of the magnetic recording medium 6 viewed from the side facing the magnetic recording head 1, FIG. 4B is an enlarged view of an area A illustrated in FIG. 4A, and FIG. 4C is a sectional view taken from a line B-B illustrated in FIG. 4B. FIG. 5 is a schematic diagram of an example of a magnetic recording apparatus 50 according to the embodiment. FIG. 6 is a schematic diagram for explaining a thermally assisted magnetic recording method according to the embodiment.

In the drawings, X indicates a film-thickness direction of the magnetic recording head 1 and a down-track direction of the magnetic recording medium 6, Y indicates a core-width direction of the magnetic recording head 1 and a cross-track direction of the magnetic recording medium 6, and Z indicates an element height direction of the magnetic recording head 1.

In the thermally assisted magnetic recording method according to the embodiment, a so-called “bit-patterned media” in which recording bits are physically (i.e., thermally and electrically) separated from one another is used as a magnetic recording medium, and desired information is recorded as magnetic information in the magnetic recording medium in such a manner that electric current is selectively applied to a recording bit, the recording bit is heated by Joule heat so that coercivity of the recording bit can be reduced to a desired level, and an external magnetic field is applied to the heated recording bit from a magnetic recording head.

More particularly, the magnetic recording head is structured such that a tunneling current wiring is arranged near a recording magnetic pole so that tunneling current can flow between the magnetic recording head and each of the recording bits of the magnetic recording medium. Besides, the magnetic recording medium is structured such that a heating layer 42 made of material with high specific resistance is formed for each of the recording bits so that Joule heat can be effectively generated.

A configuration of the magnetic recording head 1 according to the embodiment is described below using an example of a magnetic recording head for perpendicular recording. However, the following configuration is by way of example only, and the present invention is not limited to this example.

As illustrated in FIGS. 1 and 2, the magnetic recording head 1 is configured as, as one embodiment of the present invention, an integrated magnetic head that includes a read head portion 2 and a write head portion 3. However, the present invention is not limited to the integrated magnetic head. FIG. 1 illustrates a sectional view of the magnetic recording head 1 viewed from a direction perpendicular to the core-width direction, and FIG. 2 illustrates an end view of the magnetic recording head 1 viewed from the medium facing surface 5 side. The medium facing surface 5 is formed at a predetermined position of the magnetic recording head 1 by performing a polishing process after a lamination process of each layer is completed.

A configuration example of the read head portion 2 is described below. A lower shield layer 12 of the read head portion 2 is formed on a wafer substrate (not illustrated in the drawings) that functions as a base.

A read element 13 is formed on the lower shield layer 12. The read element 13 can be, for example, magneto-resistive effect read element such as TMR element or GMR element, and any arbitrary film configurations can be employed.

Hard bias films (not illustrated in the drawings) are formed on both sides of the read element 13 (front and back sides in FIG. 1), and an insulating film 30 made of Al₂O₃ or the like is formed at the back of the read element 13.

An upper shield layer 14 is formed on the read element 13, the insulating film 30, and the hard bias films. The upper shield layer 14 and the lower shield layer 12 are made of magnetic material (soft magnetic material) such as NiFe.

A configuration example of the write head portion 3 is described below. An insulating film 31 made of Al₂O₃ or the like is formed on the upper shield layer 14.

A tunneling current wiring 15 made of non-magnetic conductive metallic material is formed on the insulating film 31.

An insulating film 32 made of Al₂O₃ or the like is formed such that it covers the tunneling current wiring 15.

A first return yoke 16 is formed on the entire surface of the insulating film 32.

An insulating film 33 made of Al₂O₃ or the like is formed on the first return yoke 16. First coils 17 made of conductive material are formed on the insulating film 33 in a planer spiral manner.

An insulating film 34 made of Al₂O₃ or the like is formed between and on the first coils 17.

A main magnetic pole 20 made of ferromagnetic material such as CoFe is formed on the insulating film 34. The main magnetic pole 20 generates, as the action thereof, a magnetic field in directions from the main magnetic pole 20 toward the first return yoke 16 and a second return yoke 22 and in opposite directions. In other words, the magnetic field acts as an external magnetic field for recording on the magnetic recording medium 6.

A back gap 19 is formed at the back of the main magnetic pole 20. An insulating film 35 made of Al₂O₃ or the like is formed on the main magnetic pole 20. Second coils 18 made of conductive material are formed on the insulating film 35 such that they surround the back gap 19. A trailing shield 21 made of magnetic material is formed at a position above a front end of the main magnetic pole 20 such that a space (referred to as a trailing gap) is maintained between the main magnetic pole 20 and the trailing shield 21. An insulating film 36 is formed between and on the second coils 18. The second return yoke 22 is formed on the insulating film 36 such that the second return yoke 22 is connected to the back gap 19 and the trailing shield 21.

A protection layer (not illustrated in the drawings) is formed on the second return yoke 22. In this manner, the magnetic recording head 1 having a predetermined layer structure is completed.

A configuration of the tunneling current wiring 15 as a salient feature of the embodiment is described in detail below.

A wiring size of a portion of the tunneling current wiring 15 exposed on the medium facing surface 5 (see FIG. 2) is preferably set to be equal to or smaller than a bit size of a recording bit 7 of the magnetic recording medium 6 (dimensions in the down-track direction and in the cross-track direction).

For example, to achieve a recording density of as much as 1 Tbpsi (Terabits per square inch), the wiring size of the portion exposed on the medium facing surface 5 (dimensions in the film-thickness direction and in the core-width direction) is set to be equal to or smaller than 25 nanometers (in the embodiment, 20 nanometers).

As another example of the configuration of the magnetic recording head 1, as illustrated in FIG. 3, it is possible to arrange a plurality of the tunneling current wirings 15 in the core-width direction. In this case, the tunneling current wirings 15 are formed such that an interval between adjacent ones of the tunneling current wirings 15 (an interval in the core-width direction) is set to be equal to an interval between adjacent ones of the recording bits 7 of the magnetic recording medium 6 (an interval in the cross-track direction) (see FIG. 4B).

With this configuration, it is possible to increase the number of bits to be written simultaneously. As a result, a write speed can be increased.

Regarding the recording magnetic pole (i.e., the main magnetic pole 20), if the bit size of each of the recording bits 7 of the magnetic recording medium 6 is made smaller, in the conventional technology, the size of the main magnetic pole of the magnetic recording head (dimensions in the film-thickness direction and in the core-width direction) needs to be made smaller in accordance with the recording bit. However, according to the present invention, the recording bits 7 in which signals are written are configured to be selectively heated through application of tunneling current. Therefore, the size of the main magnetic pole 20 need not be made smaller. In other words, even if the size of the main magnetic pole 20 is set to about, for example, 300 nanometers as set for a current magnetic pole, higher recording density than current recording density can be achieved.

A configuration of the magnetic recording medium 6 according to the embodiment is described below.

As illustrated in FIGS. 4A to 4C, the magnetic recording medium 6 has a layered structure formed of a conductive underlayer 43, the heating layer 42, and a recording magnetic layer 41. In at least the heating layer 42 and the recording magnetic layer 41, a separating layer 44 is arranged so that adjacent ones of the recording bits 7 can be electrically separated from each other. The separating layer 44 is preferably made of insulating material with low thermal conductivity with respect to the recording magnetic layer 41 so that the recording bits 7 can be electrically and thermally separated from one another in the cross-track direction and in the down-track direction. For example, the separating layer 44 can be made of lead glass with thermal conductivity of 0.6 W/mK.

The conductive underlayer 43 is formed such that a portion thereof in the film width direction is isolated by an insulator with respect to each recording track.

In the conventional thermally assisted method using a light, if a beam spot size of the light becomes equal to or larger than a recording bit size, erroneous data writing (side erasing) in an undesired recording bit may occur. However, according to the embodiment with the above-described configuration, the recording bits can be thermally separated from one another in the cross-track direction by using an insulating material with lower thermal conductivity than that of the recording magnetic layer 41. Therefore, heat conduction towards adjacent tracks can be suppressed. As a result, side erasing, which has been a problem in the conventional technology, can be prevented. Furthermore, with use of an insulator having low thermal conductivity between the recording bits 7 in the down-track direction, recording resolution in the down-track direction can be improved.

To perform thermally assisted magnetic recording, the recording magnetic layer 41 of the magnetic recording medium 6 generally need to be heated to about 100 kelvins. To efficiently heat the recording magnetic layer 41, the heating layer 42 is preferably made of material with high resistance. Examples of the material with high resistance include TiO₂ and heater glass.

On the other hand, the recording magnetic layer 41 is made of material having coercivity that is maintained high at room temperature at which data recording using external magnetic field is not allowed, and that is reduced when the recording magnetic layer 41 is heated to a predetermined temperature at which data recording can be performed. Examples of such material includes Co/Pd multilayer film, Co/Pt multilayer film, Co₃Pt alloy film, CoPt₃ FePd alloy film, CoPt alloy film, and FePt alloy film.

For example, assuming that the recording magnetic layer 41 is made of Fe, a cross-sectional area of the recording bit 7 is set to 150 nm², and a height (a layer thickness) is set to 5 nanometers, because Fe has specific heat of 440 J·kg⁻¹·K⁻¹ and specific gravity of 7874 kg·m⁻³, energy of 2.6×10¹⁶ joules is to be used to raise a temperature to 100 kelvins. If the heating layer 42 is made of TiO₂ having specific resistance of 8×10⁻³ ohm meters, the cross sectional area of the recording bit 7 is set to 150 nm², and the height (the layer thickness) is set to 100 nanometers, and when a current pulse of (0.1 microampere)·(5 nanoseconds) is applied, Joule heat of 2.7×10⁻¹⁶ joules is generated. Therefore, the recording magnetic layer 41 can be heated in a desired manner. The above description is by way of example only, and the specific resistance, the area of the recording bit, the layer thickness can be changed as appropriate depending on the magnetic recording apparatus.

A schematic configuration of a magnetic recording apparatus according to the embodiment, that is, a magnetic recording apparatus including the magnetic recording head 1 and the magnetic recording medium 6 according to the embodiment, is illustrated in FIG. 5. The magnetic recording apparatus 50 is an HDD that implements the thermally assisted magnetic recording method.

A general configuration of the magnetic recording apparatus 50 is the same as that of a known HDD. More particularly, in the magnetic recording apparatus 50, the magnetic recording head 1 is built in a head slider 52 for writing and reading information in and from the magnetic recording medium 6 (i.e., a magnetic recording disk 51), and the head slider 52 is mounted on a disk facing surface of a head suspension 53. The magnetic recording apparatus 50 also includes a rotatable actuator arm 54 on which an end of the head suspension 53 is fixed and a circuit that is electrically connected to the read element 13 (i.e., the magneto-resistive effect element) through an insulated conductive line on the head suspension 53 and the actuator arm 54 for detecting an electrical signal to read information recorded on the magnetic recording disk 51.

While an HDD is described as an example of the magnetic recording apparatus, the present invention is not limited to this example.

An information recording operation performed by the magnetic recording apparatus 50 is described below. As illustrated in FIG. 6, when information is recorded in the magnetic recording medium 6 rotating in the direction indicated by an arrow R, tunneling current is applied to a desired one of the recording bits 7 of the magnetic recording medium 6 from an end of the tunneling current wiring 15 on the medium facing surface 5 side (indicated by a dashed arrow illustrated in FIG. 6).

The tunneling current is conveyed to the heating layer 42 of the magnetic recording medium 6, so that the heating layer 42 is heated. Consequently, the recording magnetic layer 41 is heated to a predetermined temperature and coercivity of the recording magnetic layer 41 is reduced accordingly.

Then, a recording magnetic field from the main magnetic pole 20 (or toward the main magnetic pole 20) is applied to the recording bit 7 (the recording magnetic layer 41) of the magnetic recording medium 6, so that the information can be magnetically recorded in the magnetic recording medium 6 (the recording magnetic layer 41).

The recording magnetic layer 41 is then cooled to room temperature and thus the coercivity increases, so that the magnetically-recorded information can be assured.

In this manner, in the thermally assisted magnetic recording method according to the embodiment, the tunneling current is applied to a desired recording bit of the magnetic recording medium opposing to an end portion of the tunneling current wiring of the magnetic recording head. Therefore, it is possible to heat only the desired recording bit. Thus, information recording can be selectively performed. As a result, recording resolution can be improved.

In other words, the thermal fluctuation of recorded information (magnetization) caused by size reduction of the recording bit as a result of increase in the recording density of an HDD can be prevented, and at the same time, high-density recording as much as 1 Tbpsi can be achieved.

Furthermore, arrangement of a plurality of the tunneling current wirings in the core-width direction enables multiple recording in a plurality of recording bits in the cross-track direction. Therefore, a write speed can be increased.

Moreover, the size of the main magnetic pole of the magnetic recording head need not be made smaller, so that design margin in a manufacturing process can be enhanced. Furthermore, unlike the thermally assisted magnetic recording method using a light, the magnetic recording head according to the embodiment can be manufactured by additionally performing a tunneling-current wiring forming process in the conventional magnetic-head manufacturing process. Therefore, the manufacturing process according to the embodiment is highly compatible with the conventional manufacturing process, so that modification can be made easier.

According to an embodiment of the present invention, tunneling current can be selectively applied from a magnetic recording head to a desired recording bit of a magnetic recording medium so that the recording bit can be heated and thus coercivity of the recording bit can be reduced to record information in the magnetic recording medium. Therefore, the size of a recording area of the magnetic recording medium can be reduced. Thus, recording resolution can be increased.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A thermally assisted magnetic recording method comprising:
applying tunneling current from a tunneling current wiring arranged on a magnetic recording head configured to fly above a magnetic recording medium having a bit pattern formed of recording bits separated from one another by an insulator to a desired recording bit of the magnetic recording medium, thereby heating the recording bit and reducing coercivity of the recording bit; and
applying an alternating magnetic field corresponding to information to be recorded from the magnetic recording head to the recording bit heated at the heating to record the information in the magnetic recording medium.

2. A magnetic recording head used in the thermally assisted magnetic recording method according to claim 1, wherein a size of the tunneling current wiring on a medium facing surface of the magnetic recording head is set to be equal to a size of the recording bit on a surface of the magnetic recording medium.

3. The magnetic recording head according to claim 2, wherein a plurality of the tunneling current wirings is arranged on the magnetic recording head.

4. A magnetic recording medium used in the thermally assisted magnetic recording method according to claim 1, wherein each of the recording bits includes a heating layer having large specific resistance.

5. A magnetic recording medium used in the thermally assisted magnetic recording method according to claim 1, wherein a conductive underlayer, a heating layer, and a recording magnetic layer are formed in a layered manner in the magnetic recording medium.

6. The magnetic recording medium according to claim 5, wherein a portion of the conductive underlayer in a film-thickness direction is isolated by an insulator with respect to each recording track.

7. A magnetic recording apparatus comprising:
a magnetic recording head used in the thermally assisted magnetic recording method according to claim 1, wherein a size of the tunneling current wiring on a medium facing surface of the magnetic recording head is set to be equal to a size of the recording bit on a surface of the magnetic recording medium; and
a magnetic recording medium used in the thermally assisted magnetic recording method according to claim 1, wherein each of the recording bits includes a heating layer having large specific resistance.
